(19) United States
(12) Patent Application Publication
(10) Pub. No.: US 2013/0223111 A1
(43) Pub. Date: Aug. 29, 2013

(54) DIGITAL CONTROL CIRCUIT FOR RESONANT POWER CONVERTERS

(71) Applicant: SYSTEM GENERAL CORPORATION, (US)

(72) Inventors: Ta-Yung YANG, Milpitas, CA (US); Chou-Sheng WANG, Keelung City (TW); Chien-Tsun HSU, Taipei City (TW); Chung-Hui YEH, New Taipei City (TW); Yi-Min HSU, Taichung City (TW); Pei-Sheng TSU, New Taipei City (TW)

(73) Assignee: SYSTEM GENERAL CORPORATION, New Taipei City (TW)

(21) Appl. No.: 13/769,616

(22) Filed: Feb. 18, 2013

Related U.S. Application Data
(60) Provisional application No. 61/602,165, filed on Feb. 23, 2012.

(51) Int. Cl. H02M 7/217

(52) U.S. Cl. CPC H02M 7/217
USPC 363/53; 363/89

(57) ABSTRACT

A resonant control circuit for a power converter is provided. The resonant control circuit includes a microcontroller, a switching-signal timer, a first PWM timer, and a signal detection circuit. The microcontroller has a memory circuit, and the memory circuit includes a program memory and a data memory. The switching-signal timer generates a first switching signal coupled to switch a transformer. The first PWM timer generates a PWM signal coupled to control a synchronous rectifying transistor of the power converter for synchronous rectifying. The signal detection circuit is coupled to an output of the power converter for generating a feedback data from a feedback signal. The microcontroller controls the first switching signal by programming the switching-signal timer in accordance with the feedback data. The microcontroller controls the first PWM signal by programming the first PWM timer in response to the first switching signal.

### CROSS REFERENCE TO RELATED APPLICATIONS

This application claims the benefit of U.S. Provisional Application No. 61/602,165, filed on Feb. 23, 2012, the contents of which are incorporated herein by reference.

### BACKGROUND OF THE INVENTION

1. Field of the Invention

The invention relates to a control circuit, and more particularly to a control circuit for resonant power converters.

2. Description of the Related Art

Resonant technology had been developed to achieve high efficiency and low noise power conversion. In recent development, power management is required to achieve better efficiency for both light load and heavy load of power converters. The present invention provides a digital control solution with an embedded microcontroller for resonant power converters to fit advanced power management needs.

### BRIEF SUMMARY OF THE INVENTION

An exemplary embodiment of a resonant control circuit for a power converter is provided. The resonant control circuit comprises a microcontroller, a switching-signal timer, a first PWM timer, and a signal detection circuit. The microcontroller has a memory circuit, and the memory circuit comprises a program memory and a data memory. The switching-signal timer generates a first switching signal coupled to switch a transformer. The first PWM timer generates a first PWM signal coupled to control a synchronous rectifying transistor of the power converter for synchronous rectifying. The signal detection circuit is coupled to an output of the power converter for generating a feedback data from a feedback signal. The microcontroller controls the first switching signal by programming the switching-signal timer in accordance with the feedback data. The microcontroller controls the first PWM signal by programming the PWM timer in response to the switching signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an exemplary embodiment of a resonant power converter in accordance with the present invention;

FIG. 2A shows waveforms of switching signals of the resonant power converter in FIG. 1;

FIG. 2B shows waveforms of switching signals, a detection signal, and a PWM signal of the resonant power converter in FIG. 1;

FIG. 3 is an exemplary embodiment of a controller of the resonant power converter in FIG. 1;

FIG. 4 is an exemplary embodiment of a resonant-signal circuit of the controller in FIG. 3;

FIG. 5 is an exemplary embodiment of a PWM circuit of the controller in FIG. 3;

FIG. 6 is an exemplary embodiment of a PWM signal generator of the PWM circuit in FIG. 5;

FIG. 7 is an exemplary embodiment of a protection circuit of the controller in FIG. 3;

FIG. 8 is an exemplary embodiment of a signal detection circuit of the controller in FIG. 3; and

FIG. 9 shows waveforms of switching signals and a switching current of the resonant power converter in FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

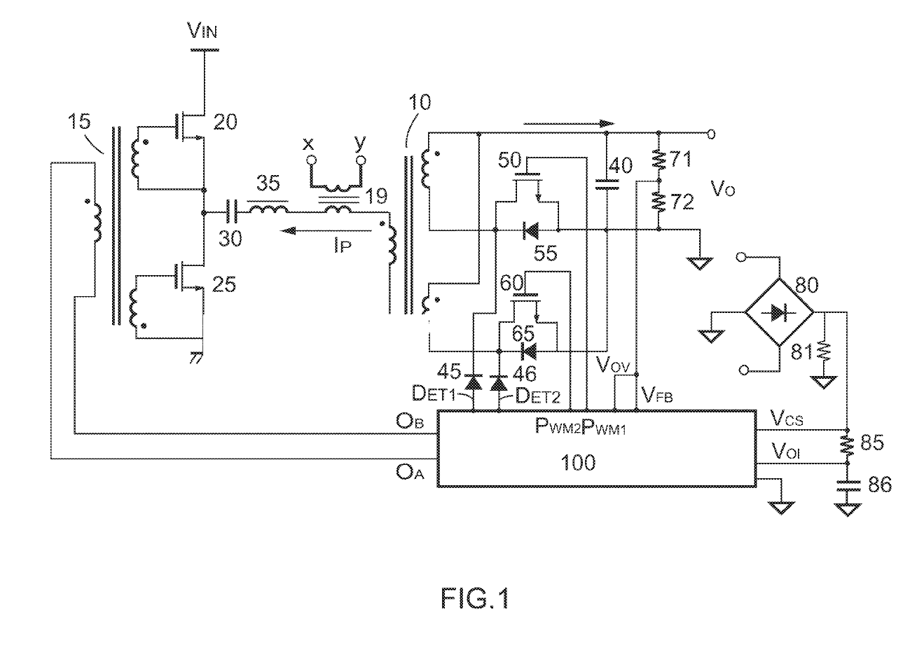

FIG. 1 is an exemplary embodiment of a resonant power converter in accordance with the present invention. Transistors 20 and 25 switch a transformer 10 through a capacitor 30 and an inductor 35. The capacitor 30 and the inductor 35 develop a resonant tank. The inductor 35 can be a part of the transformer 10, such as the leakage inductance of the transformer 10. Secondary windings of the transformer 10 generate an output voltage V_{O} at a capacitor 40 via rectifiers 55 and 65. Synchronous rectifying transistors 50 and 60 are coupled to the rectifier 55 and 65 respectively for synchronous rectifying. The rectifiers 55 and 65 can be the body diodes of the transistors 50 and 60 respectively. According to the output voltage V_{O}, resistors 71 and 72 forming a voltage divider generate a feedback signal V_{FB} coupled to a controller 100. In accordance with the feedback signal V_{FB}, the controller 100 generates switching signals O_{A} and O_{B} coupled to control the transistors 20 and 30 through a driver transformer 15. The frequency of the switching signals O_{A} and O_{B} will determine the output power of the resonant power converter.

A diode 45 is coupled to the rectifier 55 for generating a detection signal D_{ET1} to the controller 100. A diode 46 is coupled to the rectifier 65 for generating a detection signal D_{ET2} to the controller 100. When the transistor 50 is turned off, a pulled-low state of the detection signal D_{ET1} indicates that the rectifier 55 is still turned on. According to the states of the switching signals O_{A} and O_{B} and/or the detection signals D_{ET1} and D_{ET2}, the controller 100 generates signals P_{WM1} and P_{WM2} to control the transistors 50 and 60 respectively.

A current transformer 19 is coupled to the transformer 10 for detecting a switching current I_{P} of the transformer 10 and generate a current signal V_{CS} via a high speed bridge-rectifier 80 and a resistor 81. Through a resistor 85 and a capacitor 86, the current signal V_{CS} further generate an average-current signal V_{OI} for over-current protection. The current signal V_{CS} and the average-current signal V_{OI} are coupled to the controller 100. A signal V_{OV} is further coupled to the controller 100 for over-voltage protection. The level of the signal V_{OV} is correlated to the level of the output voltage V_{O}.

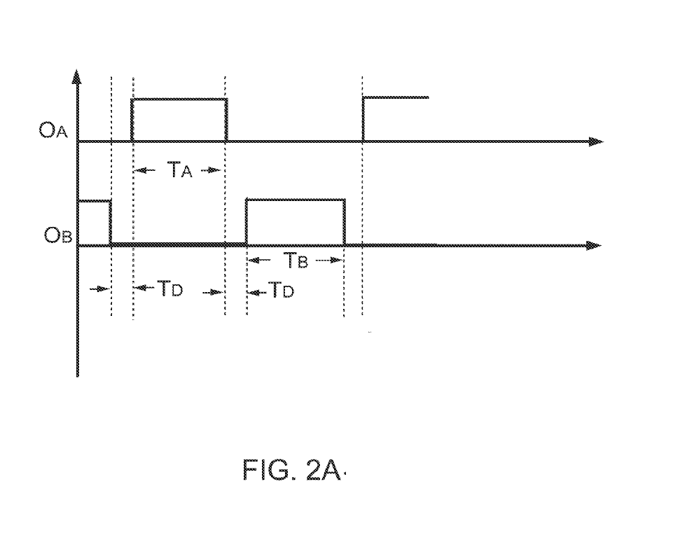

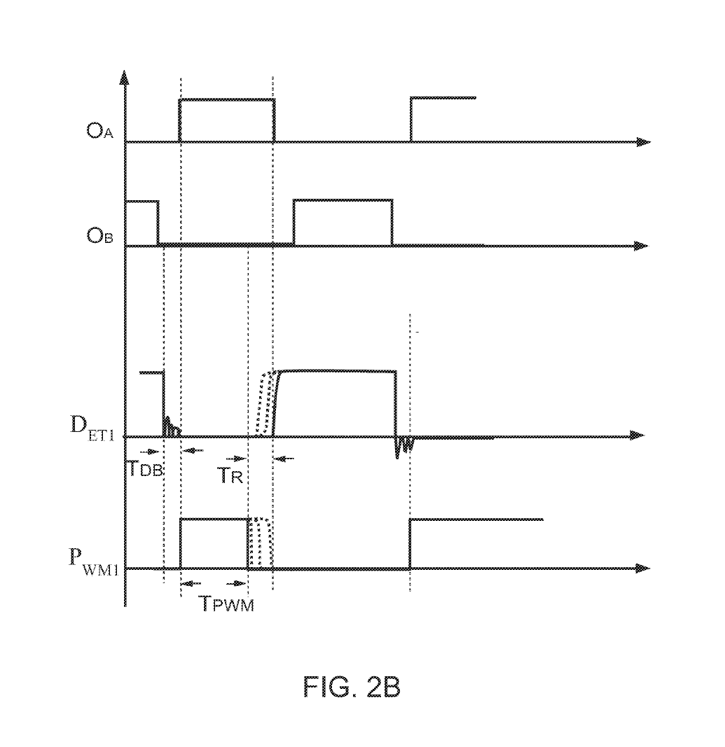

FIG. 2A shows the waveforms of the switching signals O_{A} and O_{B}. The on-time of the switching signal O_{A} is represented by T_{A}. The on-time of the switching signal O_{B} is represented by T_{B}. T_{D} represents the dead-time between the switching signals O_{A} and O_{B}. The timing of the on-time T_{A}, the on-time T_{B}, and the dead-time T_{D} is programmable by timers. Therefore, the frequency, the duty-cycle, and the pulse width of the switching signals O_{A} and O_{B} are programmable.

FIG. 2B shows the waveforms of the switching signals O_{A} and O_{B}, the detection signal D_{ET1}, and the signal P_{WM1}. When the switching signal O_{A} is “pulled-high” and/or the detection signal D_{ET1} is “pulled-low”, then the signal P_{WM1} will be generated to turn on the transistor 50 for the synchronous rectifying. T_{DB} represents de-bounce time that makes sure the detection signal D_{ET1} has been pulled low. The pulse width T_{PWM} of the signal P_{WM1} is programmable by a timer. Another timer will record timing T_{R} that starts from “the turn-off of the signal P_{WM1}” to “the pulled-high of the signal D_{ET1}”. It means the timing T_{R} records the period from “the turn-off of the transistor 50” to “the turn-off of the rectifier 55”. The timing T_{R} is utilized to program the pulse width T_{PWM} for optimizing the synchronous rectifying.

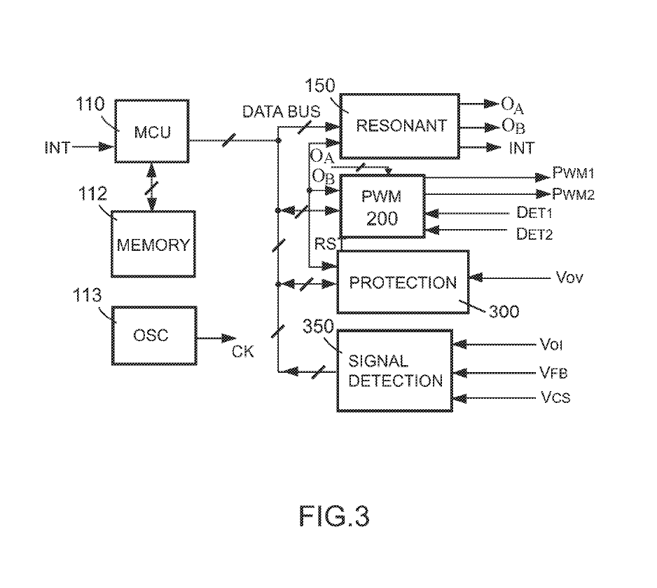

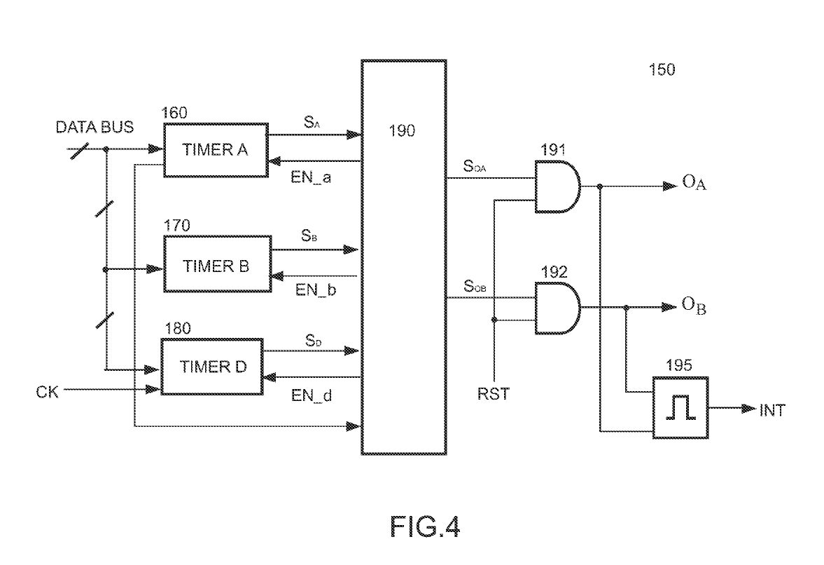

FIG. 3 is an exemplary embodiment of the controller 100. It includes a microcontroller (MCU) 110 and a memory circuit (MEMORY) 112 including a program memory and a data memory. An oscillation circuit (OSC) 113 generates a clock signal CK. Through a data bus DATA BUS, the microcontroller 110 controls a resonant-signal circuit (RESONANT) 150 to generate the switching signals O_{A} and O_{B} and an interrupt signal INT. The interrupt signal INT is coupled to interrupt the microcontroller 110 in response to the falling edges of the switching signals O_{A} and O_{B} (showed in FIG. 4). A PWM circuit (PWM) 200 is coupled to generate the signals P_{WM1} and P_{WM2} in response to the switching signals O_{A} and O_{B} and/or the detection signals D_{ET1} and D_{ET2}. The pulse widths of the signals P_{WM1} and P_{WM2} from PWM circuit (PWM) 200 are programmable by the microcontroller 110. A protection circuit (PROTECTION) 300 generates a reset signal RST coupled to turn off the switching signals O_{A} and O_{B} from the resonant-signal circuit (RESONANT) 150 and the signals P_{WM1} and P_{WM2} from the PWM circuit (PWM) 200 when the signal V_{OV} is over a threshold or a watchdog timer is overflow. A signal detection circuit (SIGNAL DETECTION) 350 is coupled to convert the feedback signal V_{FB}, the current signal V_{CS}, and the average-current signal V_{OI} to digital data for the microcontroller (MCU) 110.

FIG. 4 is an exemplary embodiment of the resonant-signal circuit 150. The resonant-signal circuit 150 includes a timer A 160 to determine the period of the on-time T_{A} of the switching signal O_{A} (shown in FIG. 2A), a timer B 170 to determine the period of the on-time T_{B} of the switching signal O_{B}, and a timer D 180 to determine the period of the dead-time T_{D}. The timer A 160 and the timer B 170 have 16-bit length data, and they can be programmed through the data bus DATA BUS. The timer D 180 is an 8-bit length timer, and it also can be programmed through the data bus DATA BUS. The output S_{A} of the timer A 160, the output S_{B} of the timer B 170, and the output S_{D} of the timer D 180 are coupled to a logic circuit 190 to generate signals S_{OA} and S_{OB}. An AND gate 191 receives the signal S_{OA} and the reset signal RST from the protection circuit 300 to generate the switching signal O_{A}. An AND gate 192 receives the signal S_{OB} and the reset signal RST to generate the switching signal O_{B}. The falling edges of the switching signals O_{A} and O_{B} will generate the interrupt signal INT through a pulse generation circuit 195.

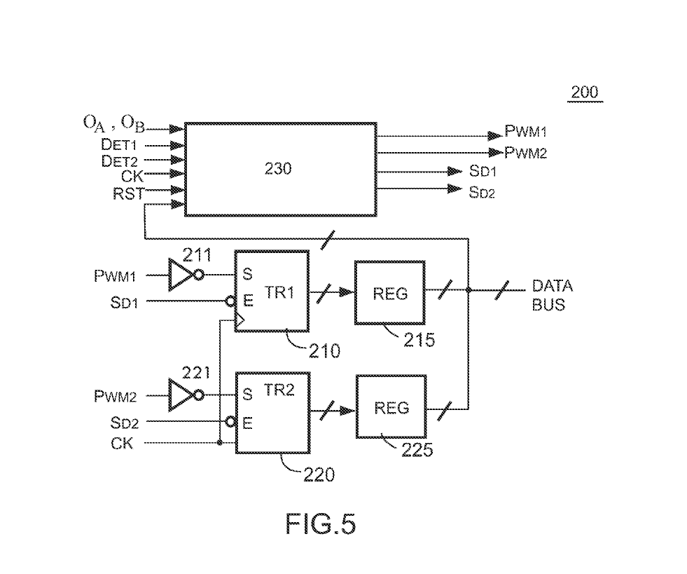

FIG. 5 is an exemplary embodiment of the PWM circuit 200. The PWM circuit 200 includes a PWM signal generator 230 for generating the signals P_{WM1} and P_{WM2} in response to the switching signals O_{A} and O_{B} and/or the detection signals D_{ET1} and D_{ET2}. The PWM signal generator 230 also generates trigger signals S_{D1} and S_{D2}. The trigger signals S_{D1} and S_{D2} are correlated to the detection signals D_{ET1} and D_{ET2}. A timer (TR1) 210, also called as synchronous rectifying (SR) timer, receives the signal P_{WM1} through an inverter 211 and further receives the trigger signal S_{D1}. The timer 210 is utilized to record the period (timing) T_{R} (shown in FIG. 2B, also called as SR-margin period) from the time point when the signal P_{WM1} is turned off (that is the transistor 50 is turned off) to the time point when the trigger signal S_{D1} has a logic low level (that is the detection signal D_{ET1} is pulled high). A timer (TR2) 220, also called as synchronous rectifying (SR) timer, receives the signal P_{WM2} through an inverter 221 and further receives the trigger signal S_{D2}. The timer 220 is utilized to record the period (timing, also called as SR-margin period) from the time point when the signal P_{WM2} is turned off (that is the transistor 60 is turned off) to the time point when the trigger signal S_{D2} has the logic low level (that the detection signal D_{ET2} is pulled high). The data of the timers 210 and 220 is stored into registers (REG) 215 and 225 respectively. The microcontroller 110 can read the data of the timers 210 and 220 (stored in the registers 215, 225) from the data bus DATA BUS.

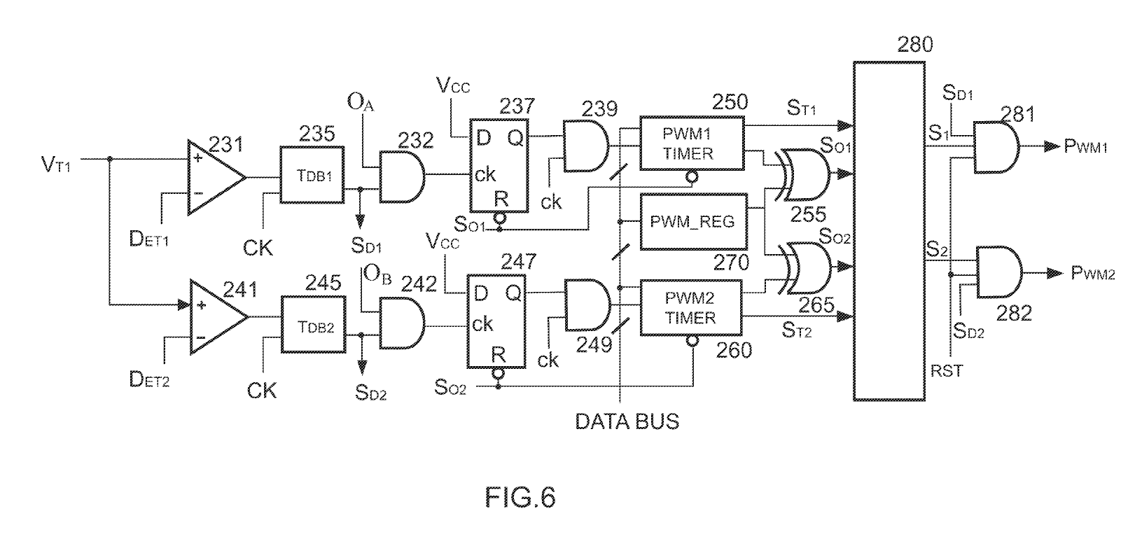

FIG. 6 is an exemplary embodiment of the PWM signal generator 230. The PWM signal generator 230 includes a comparator 231 coupled to receive the detection signal D_{ET1}. The comparator 231 will generate an output coupled to a de-bounce circuit (T_{DB1}) 235 once the detection signal D_{ET1} is higher or lower than a threshold V_{T1}. The de-bounce circuit 235 will output the trigger signal S_{D1}. The trigger signal S_{D1} and the switching signal O_{A} are coupled to an AND gate 232, and the output of the AND gate 232 is coupled to a flip-flop 237. Through an AND gate 239, the output of the flip-flop 237 is applied to control the clock signal CK for a timer (PWM1 TIMER) 250. The value of the timer 250 is programmable by the microcontroller 110 through the data bus DATA BUS.

A comparator 241 is coupled to receive the detection signal D_{ET2}. The comparator 241 will generate an output coupled to a de-bounce circuit (T_{DB2}) 245 once the detection signal D_{ET2} is higher or lower than the threshold V_{T1}. The de-bounce circuit 245 will output the trigger signal S_{D2}. The trigger signal S_{D2} and the switching signal O_{B} are coupled to and AND gate 242, and the output of the AND gate 242 is coupled to a flip-flop 247. Through an AND gate 249, the output of the flip-flop 247 is applied to control the clock signal CK for a timer (PWM2 TIMER) 260. The value of the timer 260 is programmable by the microcontroller 110 through the data bus DATA BUS.

The data of a register (PWM_REG) 270 is programmable by the microcontroller 110 via the data bus DATA BUS. When the clock signal CK is enabled for clocking the timer 250, a start signal S_{T1} will be generated. A digital comparator 255 will coupled to compare the value of the timer 250 and the value of register 270. Once the value of the timer 250 and the value of register 270 are equal, the digital comparator 255 will generate a stop signal S_{O1}. The stop signal S_{O1} is coupled to reset the flip-flop 237 and stop the clock signal CK being sent into the timer 250 through the AND gate 239. Both the start signal S_{T1} and the stop signal S_{O1} are coupled to generate the signal P_{WM1} through a logic circuit 280 and an AND gate 281.

When the clock signal CK is enabled for clocking the timer 260, a start signal S_{T2} will be generated. A digital comparator 265 will coupled to compare the value of the timer 260 and the value of register 270. Once the value of the timer 260 and the value of register 270 are equal, the digital comparator 265 will generate a stop signal S_{O2}. The stop signal S_{O2} is coupled to reset the flip-flop 247 and stop the clock signal CK coupled to the timer 260 through the AND gate 249. Both the start signal S_{T2} and the stop signal S_{O2} are coupled to generate the signal P_{WM2} through the logic circuit 280 and an AND gate 282. The reset signal RST is coupled to the AND gates 281 and 282 to turn off the signals P_{WM1} and P_{WM2} once the reset signal RST is enabled for the protection.

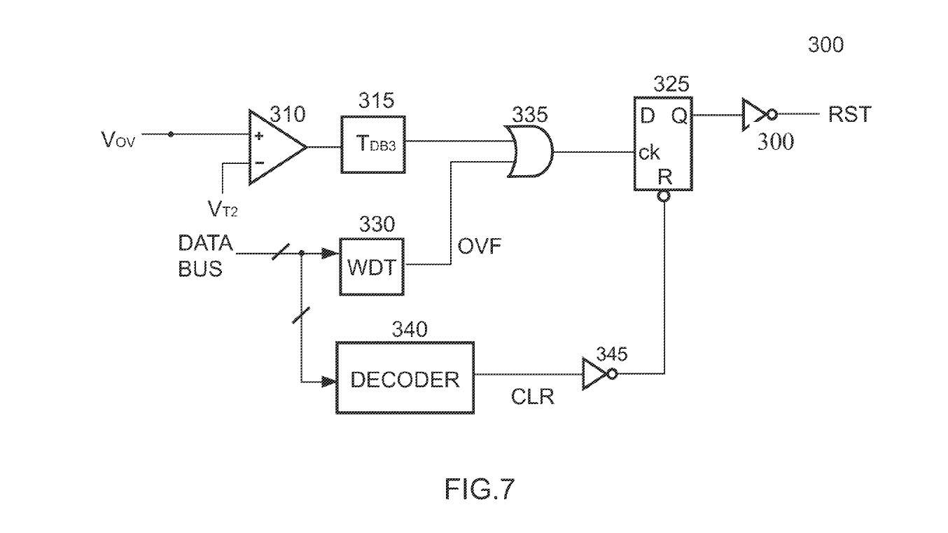

FIG. 7 is an exemplary embodiment of the protection circuit 300. A comparator 310 is coupled to receive the signal V_{OV} and compares the signal V_{OV} and a over-voltage threshold V_{T2} to generate an output signal to a de-bounce circuit (T_{DB3}) 315. The de-bounce time of the de-bounce circuit 315 is around 10 usec. The output of the de-bounce circuit 315 is coupled to a flip-flop 325 via an OR gate 335 for generating the reset signal RST through an inverter 326. Another input of the OR gate 335 is an overflow signal OVF. A watchdog timer (WDT) 330 generates the overflow signal OVF. The watchdog timer 330 is controlled by the microcontroller 110 though the data bus DATA BUS. When the protection is happened by the signal V_{OV} (such as the signal V_{OV} is higher than the over-voltage threshold V_{T2}) or the watchdog timer 330 (such as the watchdog timer 330 is running overflow), the protection state and the reset signal RST will be latched by the flip-flop 325. Only the microcontroller 110 can clear the flip-flop 325 via the data bus DATA BUS, a decoder 340 and an inverter 345, such that the turned-off states of the switching signals O_{A} and O_{B} and the turned-off states of the signals P_{WM1} and P_{WM2} are cleared by the microcontroller 110.

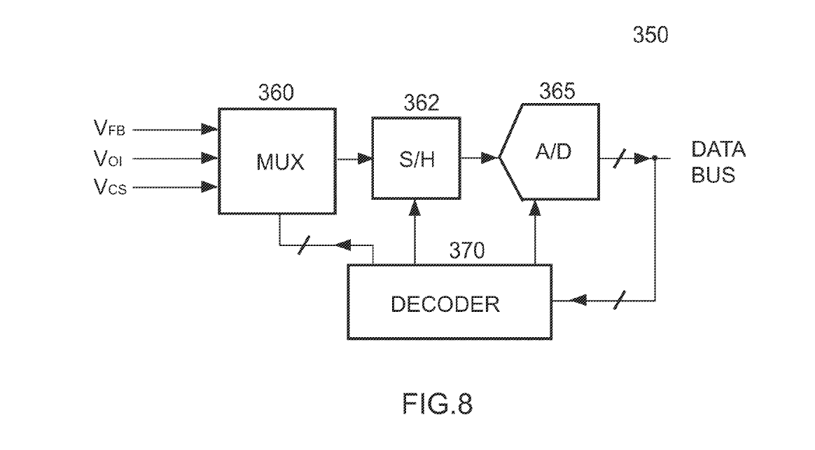

FIG. 8 is an exemplary embodiment of the signal detection circuit 350. A decoder 370 coupled to the data bus DATA BUS for generating signals to control a multiplexer (MUX) 360, a sample-and-hold circuit (S/H) 362 and an analog-to-digital converter (A/D) 365. The microcontroller 110 can read the output of the analog-to-digital converter 365 through the data bus DATA BUS. The multiplexer 360 is coupled to receive the feedback signal V_{FB}, the average-current signal V_{OI}, and the current signal V_{CS}. Therefore, the microcontroller 110 can read the information of the feedback signal V_{FB} (the feedback data), the average-current signal V_{OI}, and the current signal V_{CS}.

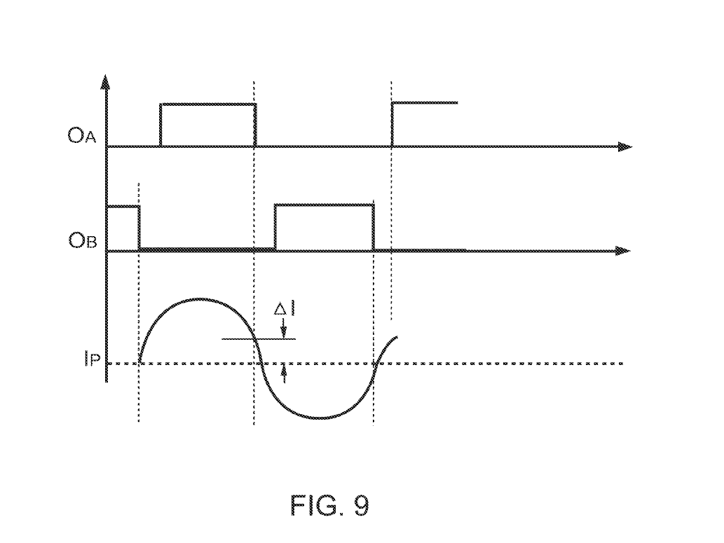

FIG. 9 shows the waveforms of the switching signals O_{A} and O_{B} and the switching current I_{P}. The switching current I_{P} is the current flowing through the transformer 10 and the current transformer 19. The switching current I_{P} can be converted to the signal V_{CS}. By measuring the current signal V_{CS} (through the signal detection circuit 350) in response to the interrupt signal INT (or in response to the falling edges of the switching signals O_{A} and O_{B}), the microcontroller 110 can detect the level of ΔI. The level of ΔI indicates the margin of the switching current I_{P} before the switching current I_{P} falls to zero current. The level of ΔI is utilized to ensure that the switching of the transistors 20 and 30 achieves zero voltage switching (ZVS). It also can make sure the resonant switching can be operated in inductive-mode. The level of ΔI also indicates the lowest switching frequency that is allowed for controlling the resonant power converter.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A resonant control circuit for a power converter comprising:
a microcontroller having a memory circuit, wherein the memory circuit comprises a program memory and a data memory;
a switching-signal timer for generating a first switching signal coupled to switch a transformer;
a first PWM timer for generating a first PWM signal coupled to control a synchronous rectifying transistor of the power converter for synchronous rectifying; and
an analog-to-digital converter coupled to an output of the power converter for generating a feedback data from a feedback signal;
wherein the microcontroller controls the first switching signal by programming the switching-signal timer in accordance with the feedback data, and the microcontroller controls the first PWM signal by programming the first PWM timer in response to the first switching signal.

2. The resonant control circuit as claimed in claim 1 further comprising:
a circuit coupled to an output rectifier of the power converter for detecting an on/off state of the output rectifier and generating a detection signal;
wherein the output rectifier can be a rectifier or a body diode of the synchronous rectifying transistor, and the detection signal is coupled to turn on the PWM signal.

3. The resonant control circuit as claimed in claim 1 further comprising:
a second switching-signal timer for generating a second switching signal; and
a third switching-signal timer for generating a dead-time between the first switching signal and the second switching signal;
wherein the microcontroller can control the second switching-signal timer and the third switching-signal timer.

4. The resonant control circuit as claimed in claim 1 further comprising:
a second PWM timer generating a second PWM signal;
wherein the microcontroller can control the second PWM timer.

5. The resonant control circuit as claimed in claim 1 further comprising:
a synchronous rectifying (SR) timer for recording an SR-margin period;
wherein the SR-margin period starts from the turn-off of the SR transistor to the turn-off of the output rectifier, and the microcontroller can read the SR-margin period.

6. The resonant control circuit as claimed in claim 1 further comprising:
a protection circuit for generating a reset signal to latch the first switching signal;
wherein the protection circuit is coupled to the output of the power converter for generating the reset signal if the output of the power converter is higher than an over-voltage threshold.

7. The resonant control circuit as claimed in claim 6, wherein the protection circuit further comprising a watchdog timer for generating the reset signal to turn off the first switching signal if the watchdog timer is running overflow.

8. The resonant control circuit as claimed in claim 6 wherein the reset signal further turns off the first PWM signal.

9. The resonant control circuit as claimed in claim 6, wherein the turned-off state of the first switching signal can be cleared by the microcontroller.

10. The resonant control circuit as claimed in claim 1 wherein the first switching signal generates an interrupt signal coupled to interrupt the microcontroller.

11. The resonant control circuit as claimed in claim 1 wherein the analog-to-digital converter is further coupled to detect a switching current of the transformer.
